(19) United States
(12) Patent Application Publication
(10) Pub. No.: US 2023/0390729 A1
(43) Pub. Date: Dec. 7, 2023

(54) DEVICE FOR SYNTHESIZING HOMOGENEOUS POLYMER SPHERES BASED ON CHANNEL PREPOLYMERIZATION, AND METHOD OF USING THE SAME

(71) Applicant: NANJING UNIVERSITY, Nanjing (CN)

(72) Inventors: Chendong SHUANG, Nanjing (CN); Dong CHEN, Nanjing (CN); Kaiwen ZHONG, Nanjing (CN); Ziwei ZHANG, Nanjing (CN); Hongyu YANG, Nanjing (CN); Weiwei ZHOU, Nanjing (CN); Aimin LI, Nanjing (CN)

(21) Appl. No.: 18/148,470

(22) Filed: Dec. 30, 2022

(30) Foreign Application Priority Data
Jun. 7, 2022 (CN) 202210634336.8

(51) Int. Cl. B01J 19/24; B01J 19/06; B01J 19/00; C08F 212/08

(52) U.S. Cl. CPC B01J 19/243; B01J 19/06; B01J 2219/00076; C08F 212/08; B01J 19/0013

(57) ABSTRACT

A homogeneous polymer sphere synthesis device based on channel prepolymerization comprises a jet vibrator, a spiral prepolymerization channel, a reactor and a water phase circulating system; two ends of the water phase circulating system are connected to the reactor and the spiral prepolymerization channel through pipes, respectively; the jet vibrator comprises a jet oil phase tank, a jet micropore plate and a vibration exciter for outputting vibration; the jet micropore plate is arranged in the jet oil phase tank; an outlet end of the spiral prepolymerization channel is connected to the reactor, while an inlet end thereof is connected to the jet oil phase tank.

### CROSS REFERENCES

This application claims priority to Chinese Patent Application Ser. No. 60/864,925 filed 8 Nov. 2006.

### TECHNICAL FIELD OF THE INVENTION

The present invention relates to the field of polymer sphere synthesis devices, and in particular to a device for synthesizing homogeneous polymer spheres based on channel prepolymerization, and a method of using the same.

### BACKGROUND OF THE INVENTION

As one kind of spherical granular polymer materials with ion exchange functional groups, ion exchange resins have been widely applied in fields such as water treatment, petrochemical industry, electric power, nuclear industry, medicament and food. Due to their advantages of fast adsorption rate, large effective exchange capacity, uniform and fast water discharge rate or the like, homogeneous resins are increasingly demanded in fields such as nuclear industry, electric power and medicament. However, the synthesis of homogeneous resins has high requirements for devices and methods. The synthesis of homogeneous resins is based on the preparation of homogeneous polymer spheres, i.e., the so-called resin white spheres in the industry.

A common method for preparing resin white spheres is suspension polymerization, where the oil phase is broken into fine oil droplets by stirring and shearing, and then polymerized at a certain polymerization temperature to form white spheres. The particle size distribution of the white spheres is mainly related to the uniformity of the droplets, so the resins obtained by the conventional suspension polymerization are characterized by a large particle size distribution. The particle size distribution of the products generally ranges from 0.3 mm to 1.2 mm, and the uniformity coefficient is generally above 1.3. The sources of conventional homogeneous resins are generally screened from the resulting products of the suspension polymerization, so that the yield is very low and lots of raw materials are wasted. Therefore, there is a need for developing novel devices and methods for manufacturing homogeneous resins.

The reason for a wide particle size distribution in the suspension polymerization is that non-uniform droplets are formed by stirring and shearing, so how to produce uniform droplets and ensure that the droplets will not be broken and coalesced before polymerization is very important in the preparation process.Jet vibration is a method to produce uniform oil droplets, but how to ensure the polymerization of uniform droplets is also very important.

Patent CN2552926Y disclosed a reactor for synthesizing homogeneous resins by suspension polymerization, wherein uniform droplets are obtained by improving the reactors and the shape and structure of the stirrer build in the reactor and by using the uniform shearing force generated by the frame stirrer and the perforated bottom plate. This reactor is limited in two aspects. Firstly, the number and distribution of pores on the perforated bottom plate have a great impact on the uniformity of droplets, so it is easy to lead to non-uniform stirring and shearing. Secondly, even if uniform droplet precursors are produced in the reactor, the droplets will be broken and coalesced at the time of stirring.

Patent CN114288949A disclosed a device and method for preparing a homogeneous resin. By providing an oil phase nozzle and a water phase nozzle on the base of the fluidized reactor, the oil is phase is uniformly split into oil droplets with the same size by using the difference in speed between two paths of fluid. How to effectively polymerize the droplets is not mentioned in this patent. After entering the reactor, the droplets will be broken by stirring. Moreover, the yield cannot be improved by using a single nozzle, and the uniformity of droplets cannot be controlled by increasing only the flow rate.

Patent CN110172117A disclosed a process for preparing a homogeneous resin, wherein a shearing force is generated by using the difference in speed between the water phase and the oil phase, so as to produce uniform oil droplets. In this process, the yield is low when a single injection pipe is used. To improve the yield, multiple pumps or a multichannel pump are needed, so that the cost and floor space will be greatly increased. In addition, how to effectively polymerize uniform droplets after being produced is not mentioned in this patent.

Patent CN104193853B disclosed a device and method for preparing a monodisperse ion exchange resin, wherein uniform droplets are produced by using a spray needle and vibration dispersion control, and the droplets are then polymerized to obtain a homogeneous resin by using a reducing pipe from bottom to top. This method also has the disadvantages of single channel and low yield, and the white spheres polymerized in the reducing pipe cannot enter the curing process in time. In addition, the resin prepared in this patent has a particle size ranging from 1 mm to 3.5 mm, but the particle size of the homogeneous resin is actually required to be 500 μm to 600 μm.

U.S. Pat. No. 113,877,499A disclosed a device for producing a homogeneous resin and a method using the same, wherein uniform droplets are obtained by using a multichannel sieve plate as a spray main body and applying vibration. Although the yield can be ensured, the reaction process of the droplets is completed in the pipe that is vertically lifted up. Thus, the height of the pipe is highly required, or the effective polymerization of the droplets cannot be ensured. If the height is too large, the device is required more highly, and a certain safety risk is caused.

In the master's theses “Study on Large-Particle Polystyrene Homogenous Resin Preparation Technology” (Zhejiang University, Xiao Yingpeng, 2018) and “Study on Influencing Factors of Uniform Droplets Formed by Liquid-Liquid Jet Vibration” (Shangdong University of Technology, Li Wenyan, 2011), the process for preparing homogenous resin by vibration dispersion has been discussed, but a single dispersion needle or nozzle is used. Although the resin with a narrow particle size distribution can be prepared, industrialization is limited by the inherent defects of the single channel.

In conclusion, although there are many studies and technical outcomes on homogenous resin production devices at present, these technical methods are generally low in yield and difficult to expand production, and most of these devices and technologies only involve the generation of uniform droplets but have no design on how to ensure the effective polymerization of droplets, i.e., how to ensure that the droplets are not broken and coalesced before polymerization.

### SUMMARY OF THE INVENTION

In view of the deficiencies of the prior art, an objective of the present invention is to provide a device for synthesizing homogeneous polymer spheres based on channel prepolymerization and a method of using the same, which can overcome the problem of low yield caused by a single channel, realize the stability of vibration jet in multiple channels and the in-time polymerization of homogeneous droplets, and realize the high yield and continuous production of homogeneous white spheres.

The present invention employs the following technical solutions.

A device for synthesizing homogeneous polymer spheres based on channel prepolymerization is provided, including a jet vibrator, a spiral prepolymerization channel, a reactor and a water phase circulating system; two ends of the water phase circulating system are connected to the reactor and the spiral prepolymerization channel through pipes, respectively; the jet vibrator includes a jet oil phase tank, a jet micropore plate and a vibration exciter for outputting vibration; the jet micropore plate is arranged in the jet oil phase tank; and, an outlet end of the spiral prepolymerization channel is connected to the reactor, while an inlet end thereof is connected to the jet oil phase tank.

The jet vibrator of the device further includes a vibration platform, a vibration controller and a jet pump; the vibration exciter cooperates with the vibration controller and the vibration platform and is arranged in the vibration platform; the jet pump is used in combination with the jet oil phase tank and the jet micropore plate; and, the controllable flow range of the jet pump is 0.5 mL/min to 200 mL/min.

The water phase circulating system of the device includes a circulating pump and a condenser; a junction of the water phase circulating system with the reactor is located below an operating liquid level of the reactor; and, a filter head is provided at the end of the water phase circulating system connected to the reactor.

In a preferred solution, the circulating pump has a flow rate of 0 mL/min to 2000 mL/min, and the filter head has an aperture of 5 μm to 1000 μm.

In a preferred solution, the spiral prepolymerization channel includes a heating interlayer, and the heating interlayer keeps the temperature of a water phase in the spiral prepolymerization channel at 50° C. to 98° C.

In a more preferred solution, the spiral prepolymerization channel is connected to the jet oil phase tank through a soft connection; and, a spiral pipe in the spiral prepolymerization channel has a diameter of 2 mm to 100 mm and a total length of 0.2 m to 50 m, and the spiral prepolymerization channel has a spiral diameter of 1 cm to 200 cm and a pitch o 0.5 cm to 50 cm.

The jet micropore plate of the device has a thickness of 0.5 mm to 5 mm, an aperture of 10 μm to 500 μm and a perforation rate of 0.0001% to 0.1%.

A method of using the above device for synthesizing homogeneous polymer spheres based on channel prepolymerization is provided, including the following steps of:
(1) adding an oil phase to the jet oil phase tank, and adding a water phase to the spiral prepolymerization channel and the reactor;
(2) keeping the temperature of the water phase in the spiral prepolymerization channel at 50° C. to 98° C. and the temperature of the water phase in the reactor at 70° C. to 100° C., activating the vibration exciter, and activating the circulating pump and the condenser; and
(3) continuously pumping the oil phase into the jet oil phase tank, and making oil droplets, which are generated by the oil phase through the jet micropore plate, pass through the spiral prepolymerization channel under the action of excited vibration so as to enter the reactor, and keeping the temperature for 1 h to 10 h, preferably 4 h to 10 h.

In a preferred solution, the oil droplets reside in the spiral prepolymerization channel for 1 min to 200 min.

The vibration exciter has a vibration frequency of 1 Hz to 1000 Hz, preferably 10 Hz to 100 Hz, and has a vibration amplitude of 0.1 μm to 10 mm, preferably 0.1 μm to 8 mm.

The present invention has the following beneficial effects.
(1) The used jet vibrator uses a multichannel micropore plate and the vibrator as its main body. By usingthe multichannel micropore plate, multiple uniform column flows can be generated, and the stable jet can be broken into uniform droplets under certain vibration conditions, so that the number of droplets in the prior art can be multiplied in a unit time, and the requirements of a high yield of homogeneous white spheres can be satisfied.
(2) The spiral prepolumerization channel can satisfy that requirement that the droplets will not be broken and coalesced after entering the reactor, and a larger number of uniform droplets will naturally enter the reactor for temperature preservation after being polymerized to a certain extent, thereby achieving the technical effect of continuously operating sphere spraying, prepolumerization and curing.
(3) By using the water phase circulating system, the control of the residence time of the droplets and the recycling of the water phase in the reactor can be realized, thus bringing about great economic benefits.
(4) In the present invention, by adjusting the vibration frequency, the vibration amplitude, the concentration of the continuous phase, the proportion of the dispersed phase, the flow rate and the temperature, the particle size and particle size distribution of the produced droplets and white spheres can be controlled to obtain resin white spheres with a proper particle size. Moreover, the technical operation range is wide, and the final products are uniform in particle size. In addition, the coefficient of uniformity is below 1.2, and the particle size ranges from 100 μm to 2000 μm.

### BRIEF DESCRIPTION OF THE DRAWINGS

FIG. 1 is a schematic structure diagram of the present invention;

in which: 1: vibration exciter; 2: vibration platform; 3: jet oil phase tank; 4: jet micropore plate; 5: soft connection; 6: spiral prepolymerization channel; 7: vibration controller; 8: jet pump; 9: condenser; 10: circulating pump; 11: filter head; and, 12: reactor.

### DETAILED DESCRIPTION OF THE INVENTION

The present invention will be further described below by embodiments with reference to the accompanying drawings, and these embodiments do not constitute any limitations to the present invention.

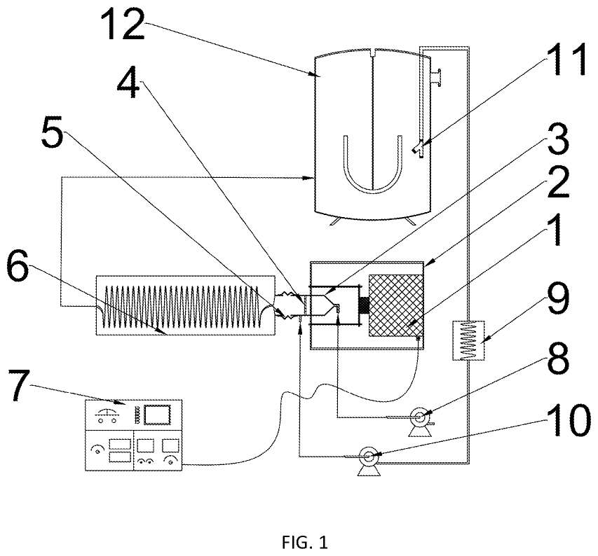

As shown in FIG. 1, the present invention provides a device for synthesizing homogeneous polymer spheres based on channel prepolymerization, including a jet vibrator, a spiral prepolymerization channel 6, a reactor 12 and a water phase circulating system. Two ends of the water phase circulating system are connected to the reactor 12 and the spiral prepolymerization channel 6 through pipes, respectively. The jet vibrator includes a jet oil phase tank 3, a jet micropore plate 4 and a vibration exciter 1 for outputting vibration. The jet micropore plate 4 is arranged in the jet oil phase tank 3. An outlet end of the spiral prepolymerization channel 6 is connected to the reactor 12, while an inlet end thereof is connected to the jet oil phase tank 3.

The jet vibrator is used to produce uniform oil droplets, and its core includes a jet oil phase tank 3, a jet micropore plate 4 and a vibration exciter 1. In a preferred solution, the jet vibrator further includes a vibration platform 2, a vibration controller 7 and a jet pump 8. The vibration exciter 1 cooperates with the vibration controller 7 and the vibration platform 2, and is arranged in the vibration platform 2. The jet pump 8 is used in combination with the jet oil phase tank 3 and the jet micropore plate 4. The controllable flow range of the jet pump 8 is 0.5 mL/min to 200 mL/min. By adjusting the vibration waveform, the vibration frequency, the vibration amplitude or the like through the vibration controller 7, the vibration exciter 1 has the following controllable range: a vibration frequency of 1 Hz to 1000 Hz, and a vibration amplitude of 1 μm to 10 mm. The jet micropore plate 4 can realize a stable multichannel vibration jet so as to obtain a large number of uniform oil droplets. The uniform droplets are timely polymerized in the provided water phase and temperature conditions, so that the stability of the droplets under stirring after entering the reactor for 12 h is ensured.

In a preferred solution, the jet micropore plate 4 has a thickness of 0.5 mm to 5 mm, an aperture of 10 μm to 500 μm and a perforation rate of 0.0001% to 0.1%.

In the device, an outlet end of the spiral prepolymerization channel 6 is connected to the reactor 12, while an inlet end thereof is connected to the jet oil phase tank 3 in the jet vibrator. To provide the water phase and temperature condition for the droplets, the spiral pipe is long enough for the droplets to stay for a long time to complete polymerization, so that the stability of the droplets under stirring after entering the reactor is ensured. The spiral prepolymerization channel 6 is connected to the jet oil phase tank 3 through a soft connection 5.

In a preferred solution, the spiral pipe in the spiral prepolymerization channel 6 has a diameter of 2 mm to 100 mm and a total length of 0.2 m to 50 m, and the spiral prepolymerization channel 6 has a spiral diameter of 1 cm to 200 cm and a pitch of 0.5 cm to 50 cm. The soft connection 5 is made of silicone, polyurethane, polytetrafluoroethylene, soft steel, rubber, etc.

The spiral prepolymerization channel 6 includes a heating interlayer, and the heating interlayer keeps the temperature of the water phase in the spiral prepolymerization channel 6 at 50° C. to 98° C.Preferably, the heating interlayer of the spiral prepolymerization channel 6 may be a hot water jacket, an oil bath jacket, an electric heating jacket, etc.

In addition, the reactor 12 of the device has stirring and heating functions for providing proper reaction conditions.

In a preferred solution, the water phase circulating system includes a circulating pump 10 and a condenser 9. A junction of the water phase circulating system with the reactor 12 is located below an operating liquid level of the reactor 12. A filter head 11 is provided at the end of the water phase circulating system connected to the reactor 12. The water phase circulating system can realize the control of the residence time of the droplets and the recycling of the water phase in the reactor 12.

The circulating pump 10 of the device has a flow rate of 0 mL/min to 2000 mL/min. The filter head 11 is arranged in the reactor 12, and the aperture of the filter head 11 μm is 5 to 1000 μm. Preferably, the filter head 11 may be a Y-shaped filter, a filter screen, a filter, etc.

A method of using the device includes the following steps.
1. An oil phase is added to the jet oil phase tank 3, and a water phase is added to the spiral prepolymerization channel 6 and the reactor 12.
2. The temperature of the water phase in the spiral prepolymerization channel 6 is kept at 50° C. to 98° C., and the temperature of the water phase in the reactor is kept at 70° C. to 100° C. The vibration exciter 1 is activated, and the circulating pump 10 and the condenser 9 are activated.
3. The oil phase is continuously pumped into the jet oil phase tank 3, and oil droplets which are generated by the oil phase through the jet micropore plate 4 pass through the spiral prepolymerization channel 6 under the action of excited vibration so as to enter the reactor 12, and the temperature is kept for 1 h to 10 h, preferably 4 h to 10 h.

Preferably, the oil droplets reside in the spiral prepolymerization channel 6 for 1 min to 200 min.

In the method of using the device, the vibration exciter 1 has a vibration frequency of 1 Hz to 1000 Hz, preferably 10 Hz to 100 Hz, and has a vibration amplitude of 0.1 μm to 10 mm, preferably 0.1 μm to 8 mm.

In the present invention, the oil phase is oil phase liquid composed of an organic monomer containing double bonds, a crosslinking agent, a pore forming agent, an initiator, an inorganic additive, etc.; and, the water phase is a solution containing one or more of sodium lauryl sulfate, sodium dodecyl benzene sulfonate, polyvinyl alcohol, gelatin, kieselguhr, starch, methylcellulose, sodium polyphosphate, calcium phosphate, calcium carbonate, bentonite, sodium monohydrogenphosphate, sodium dihydrogenphosphate, absolute ethyl alcohol, polyvinylpyrrolidone, sodium lignosulphonate, sodium chloride and sodium sulfate.

Embodiment 1:

In the device for synthesizing homogeneous polymer spheres based on channel prepolymerization in this embodiment, the jet micropore plate of the jet vibrator has a thickness of 0.5 mm, an aperture of 200 μm and a perforation rate of 0.1%; the jet micropore plate is fixed in the jet oil phase tank; and, the controllable flow range of the jet pump used in combination is 10 mL/min to 100 mL/min. The spiral pipe in the spiral prepolymerization channel has a diameter of 50 mm and a total length of 20 m, and the spiral prepolymerization channel has a spiral diameter of 30 cm and a pitch of 2 cm. One end of the spiral prepolymerization channel is connected to the jet oil phase tank of the jet vibrator through a soft connection made of soft steel, while the other end thereof is connected to the reactor though a pipe. The junctions are located on the bottom of the reactor. In the water phase circulating system, the filter head is a Y-shaped filter with an aperture of 200 μm, the condenser is a spiral condenser with a condensation interlayer, and the circulating pump has a maximum flow rate of 2000 mL/min.

The specific steps will be given below.
(1) An oil phase containing the monomer styrene, the crosslinking agent divinylbenzene and the initiator azodiisobutyronitrile at a ratio of 93:7:1 was prepared, and a water phase mixed solution containing sodium phosphate with a concentration of 0.1%, gelatin with a concentration of 0.5% and sodium chloride with a concentration of 0.01% was prepared. The vibration vibrator was activated, the vibration frequency was adjusted as 500 Hz, and the vibration amplitude was adjusted as 0.2 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 80° C., and the temperature of the water phase in the reactor was kept at 85° C. The jet pump was activated, the flow rate was adjusted as 20 mL/min, and the temperature of the condenser was adjusted as 5° C. The circulating pump was activated, and the flow rate was adjusted as 2000 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., and then raised to 95° C. and kept for 3 h.

The polymer white spheres synthesized after the steps (1) to (3) had a particle size ranging from 600 μm to 800 μm, where D₅₀ was 750 μm, and the coefficient of uniformity was 1.14.

Embodiment 2:

The device in this embodiment is the same as that in Embodiment 1, but the method of using the device is different. The specific steps will be given below.
(1) An oil phase containing the monomer styrene, the crosslinking agent divinylbenzene and the initiator azodiisobutyronitrile at a ratio of 49:4:1 was prepared, and a water phase mixed solution containing polyvinyl alcohol with a concentration of 2% and sodium sulfate with a concentration of 0.01% was prepared. The vibration vibrator was activated, the vibration frequency was adjusted as 1000 Hz, and the vibration amplitude was adjusted as 0.05 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 78° C., and the temperature of the water phase in the reactor was kept at 80° C. The jet pump was activated, the flow rate was adjusted as 10 mL/min, and the temperature of the condenser was adjusted as 2° C. The circulating pump was activated, and the flow rate was adjusted as 500 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., then raised to 85° C. and kept for 2 h, and raised to 95° C. and kept for 2 h.

The polymer white spheres synthesized after the steps (1) to (3) had a particle size ranging from 900 μm to 1000 μm, where D₅₀ was 960 μm, and the coefficient of uniformity was 1.09.

Embodiment 3:

The device in this embodiment is the same as that in Embodiment 1, but the method of using the device is different. The specific steps will be given below.
(1) An oil phase containing the monomer styrene, the crosslinking agent divinylbenzene, the initiator azodiisobutyronitrile and the pore forming agent n-heptane at a ratio of 49:4:1:25 was prepared, and a water phase mixed solution containing polyvinyl alcohol with a concentration of 1% and sodium lauryl sulfate with a concentration of 0.01% was prepared. The vibration vibrator was activated, the vibration frequency was adjusted as 100 Hz, and the vibration amplitude was adjusted as 2 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 50° C., and the temperature of the water phase in the reactor was kept at 85° C. The jet pump was activated, the flow rate was adjusted as 15 mL/min, and the temperature of the condenser was adjusted as 10° C. The circulating pump was activated, and the flow rate was adjusted as 1000 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., and then raised to 95° C. and kept for 5 h.

The polymer white spheres synthesized after the steps (1) to (3) had a particle size ranging from 600 μm to 850 μm, where D₅₀ was 750 μm, and the coefficient of uniformity was 1.18.

Embodiment 4:

In the device for synthesizing homogeneous polymer spheres based on channel prepolymerization in this embodiment, the jet micropore plate of the jet vibrator has a thickness of 1 mm, an aperture of 10 μm and a perforation rate of 0.0028%; the jet micropore plate is fixed in the jet oil phase tank; and, the controllable flow range of the jet bump used in combination is 0.5 mL/min to 50 mL/min. The spiral pipe in the spiral prepolymerization channel has a diameter of 2 mm and a total length of 3 m, and the spiral prepolymerization channel has a spiral diameter of 15 cm and a pitch of 1 cm. One end of the spiral prepolymerization channel is connected to the jet oil phase tank of the jet vibrator through a soft connection made of silicone, while the other end thereof is connected to the reactor though a pipe. The junctions are located on the bottom of the reactor. The filter head in the water phase circulating system is a filter screen with an aperture of 200 μm, a silicone soft pipe with a length of 5 m is arranged in the condenser, and the circulating pump has a maximum flow rate of 500 mL/min.

The specific steps will be given below.
(1) An oil phase containing the monomer styrene, the crosslinking agent divinylbenzene and the initiator azodiisobutyronitrile at a ratio of 93:7:1 was prepared, and a water phase mixed solution containing sodium polyphosphate with a concentration of 0.01%, gelatin with a concentration of 0.1% and sodium chloride with a concentration of 0.01% was prepared. The vibration vibrator was activated, the vibration frequency was adjusted as 50 Hz, and the vibration amplitude was adjusted as 0.02 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 85° C., and the temperature of the water phase in the reactor was kept at 90° C. The jet pump was activated, the flow rate was adjusted as 5 mL/min, and the temperature of the condenser was adjusted as 3° C. The circulating pump was activated, and the flow rate was adjusted as 200 mL/min. The stirring speed in the reactor was set as 100 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 5 h at 90° C.

The polymer white spheres synthesized after the steps (1) to (3) had a particle size ranging from 100 μm to 120 μm, where D₅₀ was 115 μm, and the coefficient of uniformity was 1.07.

Embodiment 5:

The device in this embodiment is the same as that in Embodiment 4, but the method of using the device is different. The specific steps will be given below.
(1) An oil phase containing the monomer styrene, the crosslinking agent divinylbenzene and the initiator azodiisobutyronitrile at a ratio of 49:4:1 was prepared, and a water phase mixed solution containing polyvinyl alcohol with a concentration of 0.5% and sodium lauryl sulfate with a concentration of 0.01% was prepared. The vibration vibrator was activated, the vibration frequency was adjusted as 200 Hz, and the vibration amplitude was adjusted as 0.5 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 98° C., and the temperature of the water phase in the reactor was kept at 100° C. The jet pump was activated, the flow rate was adjusted as 10 mL/min, and the temperature of the condenser was adjusted as 3° C. The circulating pump was activated, and the flow rate was adjusted as 500 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 5 h at 100° C.

The polymer white spheres synthesized after the steps (1) to (3) had a particle size ranging from 300 μm to 400 μm, where D₅₀ was 358 μm, and the coefficient of uniformity was 1.09.

Embodiment 6:

The device in this embodiment is the same as that in Embodiment 4, but the method of using the device is different. The specific steps will be given below.
(1) An oil phase containing the monomer styrene, the crosslinking agent divinylbenzene and the initiator azodiisobutyronitrile at a ratio of 70:30:1 was prepared, and a water phase mixed solution containing gelatin with a concentration of 0.1% and sodium chloride with a concentration of 0.005% was prepared. The vibration vibrator was activated, the vibration frequency was adjusted as 1000Hz, and the vibration amplitude was adjusted as 0.1 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 90° C., and the temperature of the water phase in the reactor was kept at 95° C. The jet pump was activated, the flow rate was adjusted as 5 mL/min, and the temperature of the condenser was adjusted as 3° C. The circulating pump was activated, and the flow rate was adjusted as 200 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 5 h at 95° C.

The polymer white spheres synthesized after the steps (1) to (3) had a particle size ranging from 400 μm to 450 μm, where D₅₀ was 429 μm, and the coefficient of uniformity was 1.06.

Embodiment 7:

In the device for synthesizing homogeneous polymer spheres based on channel prepolymerization in this embodiment, the jet micropore plate of the jet vibrator has a thickness of 5 mm, an aperture of 500 μm and a perforation rate of 0.1%; the jet micropore plate is fixed in the jet oil phase tank; and, the controllable flow range of the jet bump used in combination is 0.5 mL/min to 200 mL/min. The spiral pipe in the spiral prepolymerization channel has a diameter of 100 mm and a total length of 30 m, and the spiral prepolymerization channel has a spiral diameter of 200 cm and a pitch of 10 cm. One end of the spiral prepolymerization channel is connected to the jet oil phase tank of the jet vibrator through a soft connection made of rubber, while the other end thereof is connected to the reactor though a pipe. The junctions are located on the bottom of the reactor. The filter head in the water phase circulating system is a filter with an aperture of 1000 μm, a spiral condensation pipe with a length of 5 m is used, and the circulating pump has a maximum flow rate of 2000 mL/min.

The specific steps will be given below.
(1) An oil phase containing the monomer styrene, the crosslinking agent divinylbenzene and the initiator azodiisobutyronitrile at a ratio of 93:7:1 was prepared, an organic additive magnetofluid with a content of 1% was added to the oil phase, and a water phase mixed solution containing sodium polyphosphate with a concentration of 1% was prepared. The vibration vibrator was activated, the vibration frequency was adjusted as 50 Hz, and the vibration amplitude was adjusted as 5 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 70° C., and the temperature of the water phase in the reactor was kept at 80° C. The jet pump was activated, the flow rate was adjusted as 100 mL/min, and the temperature of the condenser was adjusted as 5° C. The circulating pump was activated, and the flow rate was adjusted as 2000 mL/min. The stirring speed in the reactor was set as 100 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 2 h at 80° C., then raised to 90° C. and kept for 3 h, and raised to 100° C. and kept for 1 h.

The polymer white spheres synthesized after the steps (1) to (3) had a particle size ranging from 1100 μm to 1350 μm, where D₅₀ was 1198 μm, and the coefficient of uniformity was 1.19.

Embodiment 8:

The device in this embodiment is the same as that in Embodiment 7, but the method of using the device is different. The specific steps will be given below.
(1) An oil phase containing the monomer styrene, the crosslinking agent divinylbenzene, the initiator azodiisobutyronitrile and the pore forming agent n-heptane at a ratio of 40:10:1:20 was prepared, and a water phase mixed solution containing kieselguhr with a concentration of 1% was prepared. The vibration vibrator was activated, the vibration frequency was adjusted as 300 Hz, and the vibration amplitude was adjusted as 8 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 78° C., and the temperature of the water phase in the reactor was kept at 85° C. The jet pump was activated, the flow rate was adjusted as 200 mL/min, and the temperature of the condenser was adjusted as 3° C. The circulating pump was activated, and the flow rate was adjusted as 2000 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., and then raised to 95° C. and kept for 5 h.

The polymer white spheres synthesized after the steps (1) to (3) had a particle size ranging from 1750 μm to 1900 μm, where D₅₀ was 1850 μm, and the coefficient of uniformity was 1.07.

Embodiment 9:

In the device for synthesizing homogeneous polymer spheres based on channel prepolymerization in this embodiment, the jet micropore plate of the jet vibrator has a thickness of 2 mm, an aperture of 50 μm and a perforation rate of 0.0064%; the jet micropore plate is fixed in the jet oil phase tank; and, the controllable flow range of the jet bump used in combination is 0.5 mL/min to 100 mL/min. The spiral pipe in the spiral prepolymerization channel has a diameter of 20 mm and a total length of 10 m, and the spiral prepolymerization channel has a spiral diameter of 10 cm and a pitch of 3 cm. One end of the spiral prepolymerization channel is connected to the jet oil phase tank of the jet vibrator through a soft connection made of polyurethane, while the other end thereof is connected to the reactor though a pipe. The junctions are located on the bottom of the reactor. The filter head in the water phase circulating system is a filter with an aperture of 150 μm, the constant-temperature condenser cooling water is used, and the circulating pump has a maximum flow rate of 500 mL/min.

The specific steps will be given below.
(1) An oil phase containing the monomer styrene, the crosslinking agent divinylbenzene and the initiator azodiisobutyronitrile at a ratio of 93:7:1 was prepared, and a water phase mixed solution containing polyvinyl alcohol with a concentration of 1% was prepared. The vibration vibrator was activated, the vibration frequency was adjusted as 100 Hz, and the vibration amplitude was adjusted as 1 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 80° C., and the temperature of the water phase in the reactor was kept at 85° C. The jet pump was activated, the flow rate was adjusted as 10 mL/min, and the temperature of the condenser was adjusted as 2° C. The circulating pump was activated, and the flow rate was adjusted as 100 mL/min. The stirring speed in the reactor was set as 150 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 3 h at 85° C., and then raised to 90° C. and kept for 1 h.

The polymer white spheres synthesized after the steps (1) to (3) had a particle size ranging from 400 μm to 450 μm, where D₅₀ was 439 μm, and the coefficient of uniformity was 1.04.

Embodiment 10:

The device in this embodiment is the same as that in Embodiment 9, but the method of using the device is different. The specific steps will be given below.
(1) An oil phase containing the monomer methyl acrylate, the crosslinking agent divinylbenzene and the initiator benzoyl peroxide at a ratio of 90:10:1 was prepared, and a water phase mixed solution containing polyvinylpyrrolidone with a concentration of 1%, sodium sulfate with a concentration of 0.01% and absolute ethyl alcohol with a concentratin of 0.5% was prepared. The vibration vibrator was activated, the vibration frequency was adjusted as 110 Hz, and the vibration amplitude was adjusted as 2.8 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 78° C., and the temperature of the water phase in the reactor was kept at 85° C. The jet pump was activated, the flow rate was adjusted as 3 mL/min, and the temperature of the condenser was adjusted as 3° C. The circulating pump was activated, and the flow rate was adjusted as 150 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., and then raised to 95° C. and kept for 5 h.

The polymer white spheres synthesized after the steps (1) to (3) had a particle size ranging from 200 μm to 250 μm, where D₅₀ was 228 μm, and the coefficient of uniformity was 1.08.

Embodiment 11:

The device in this embodiment is the same as that in Embodiment 9, but the method of using the device is different. The specific steps will be given below.
(1) An oil phase containing the monomer methyl methacrylate, the crosslinking agent divinylbenzene and the initiator benzoyl peroxide at a ratio of 80:20:1 was prepared, and a water phase mixed solution containing polyvinylpyrrolidone with a concentration of 1% was prepared. The vibration vibrator was activated, the vibration frequency was adjusted as 70 Hz, and the vibration amplitude was adjusted as 5 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 78° C., and the temperature of the water phase in the reactor was kept at 85° C. The jet pump was activated, the flow rate was adjusted as 8 mL/min, and the temperature of the condenser was adjusted as 10° C. The circulating pump was activated, and the flow rate was adjusted as 150 mL/min. The stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 1 h at 85° C., and then raised to 95° C. and kept for 5 h.

The polymer white spheres synthesized after the steps (1) to (3) had a particle size of 450±50 μm, where D₅₀ was 478 μm, and the coefficient of uniformity was 1.11.

Embodiment 12:

In the device for synthesizing homogeneous polymer spheres based on channel prepolymerization in this embodiment, the jet micropore plate of the jet vibrator has a thickness of 0.5 mm, an aperture of 100 μm and a perforation rate of 0.0001%; the jet micropore plate is fixed in the jet oil phase tank; and, the controllable flow range of the jet bump used in combination is 0.5 mL/min to 10 mL/min. The spiral pipe in the spiral prepolymerization channel has a diameter of 2 mm and a total length of 0.2 m, and the spiral prepolymerization channel has a spiral diameter of 1 cm and a pitch of 0.5 cm. One end of the spiral prepolymerization channel is connected to the jet oil phase tank of the jet vibrator through a soft connection made of polytetrafluoroethylene, while the other end thereof is connected to the reactor though a pipe. The junctions are located on the bottom of the reactor. The filter head in the water phase circulating system is a filter with an aperture of 80 μm, the constant-temperature condenser cooling water is used, and the circulating pump has a maximum flow rate of 50 mL/min.

The specific steps will be given below.
(1) An oil phase containing the monomer styrene, the crosslinking agent divinylbenzene and the initiator azodiisobutyronitrile at a ratio of 93:7:1 was prepared, and a water phase mixed solution containing kieselguhr with a concentration of 1% was prepared. The vibration vibrator was activated, the vibration frequency was adjusted as 10 Hz, and the vibration amplitude was adjusted as 0.01 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 78° C., and the temperature of the water phase in the reactor was kept at 90° C. The jet pump was activated, the flow rate was adjusted as 0.5 mL/min, and the temperature of the condenser was adjusted as 5° C. The circulating pump was activated, and the flow rate was adjusted as 10 mL/min. The stirring speed in the reactor was set as 150 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 10 h at 90° C.

The polymer white spheres synthesized after the steps (1) to (3) had a particle size of 200±30 μm, where D₅₀ was 214 μm, and the coefficient of uniformity was 1.08.

Embodiment 13:

The device in this embodiment is the same as that in Embodiment 12, but the method of using the device is different. The specific steps will be given below.
(1) An oil phase containing the monomer styrene, the crosslinking agent divinylbenzene, the initiator benzoyl peroxide and the pore forming agent methylbenzene at a ratio of 80:20:1:40 was prepared, and a water phase mixed solution containing polyvinyl alcohol with a concentration of 1% and calcium carbonate with a concentration of 0.05% was prepared. The vibration vibrator was activated, the vibration frequency was adjusted as 80 Hz, and the vibration amplitude was adjusted as 0.03 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 60° C., and the temperature of the water phase in the reactor was kept at 78° C. The jet pump was activated, the flow rate was adjusted as 0.75 mL/min, and the temperature of the condenser was adjusted as 10° C. The circulating pump was closed, and the stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. At the end of flow jetting, the temperature was raised to 85° C. and kept for 1 h, and then raised to 95° C. and kept for 5 h.

The polymer white spheres synthesized after the steps (1) to (3) had a particle size of 350±50 μm, where D₅₀ was 379 μm, and the coefficient of uniformity was 1.06.

Embodiment 14:

The device in this embodiment is the same as that in Embodiment 12, but the method of using the device is different. The specific steps will be given below.
(1) An oil phase containing the monomer styrene, the crosslinking agent divinylbenzene, the initiator benzoyl peroxide and the pore forming agent dichloroethane at a ratio of 80:20:1:30 was prepared, and a water phase mixed solution containing polyvinyl alcohol with a concentration of 1% was prepared. The vibration vibrator was activated, the vibration frequency was adjusted as 200 Hz, and the vibration amplitude was adjusted as 3 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 85° C., and the temperature of the water phase in the reactor was kept at 95° C. The jet pump was activated, the flow rate was adjusted as 1.0 mL/min, and the temperature of the condenser was adjusted as 10° C. The circulating pump was closed, and the stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. At the end of flow jetting, the temperature was kept for 5 h in the reactor.

The polymer white spheres synthesized after the steps (1) to (3) had a particle size of 450±50 μm, where D₅₀ was 482 μm, and the coefficient of uniformity was 1.09.

Embodiment 15:

The device in this embodiment is the same as that in Embodiment 12, but the method of using the device is different. The specific steps will be given below.
(1) An oil phase containing the monomer styrene, the crosslinking agent divinylbenzene, the initiator benzoyl peroxide and the pore forming agent 2-ethyl-1-hexanoic acid at a ratio of 92:8:1:50 was prepared, and a water phase mixed solution containing polyvinyl alcohol with a concentration of 1% was prepared. The vibration vibrator was activated, the vibration frequency was adjusted as 60 Hz, and the vibration amplitude was adjusted as 10 μm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 85° C., and the temperature of the water phase in the reactor was kept at 95° C. The jet pump was activated, the flow rate was adjusted as 1.0 mL/min, and the temperature of the condenser was adjusted as 10° C. The flow rate of the circulating pump was kept at 5 mL/min, and the stirring speed in the reactor was set as 200 r/min.
(3) The oil phase was continuously pumped into the jet oil phase tank. The oil phase passed through the jet micropore plate to produce oil droplets under the action of vibration, and then entered the reactor through the spiral prepolymerization pipe. At the end of flow jetting, the temperature was kept for 5 h in the reactor.

The polymer white spheres synthesized after the steps (1) to (3) had a particle size of 550±50 μm, where D₅₀ was 587 μm, and the coefficient of uniformity was 1.12.

Embodiment 16:

In the device for synthesizing homogeneous polymer spheres based on channel prepolymerization in this embodiment, the jet micropore plate of the jet vibrator has a thickness of 3 mm, an aperture of 300 μm and a perforation rate of 0.05%; the jet micropore plate is fixed in the jet oil phase tank; and, the controllable flow range of the jet bump used in combination is 0.5 mL/min to 50 mL/min. The spiral pipe in the spiral prepolymerization channel has a diameter of 10 mm and a total length of 50 m, and the spiral prepolymerization channel has a spiral diameter of 200 cm and a pitch of 50 cm. One end of the spiral prepolymerization channel is connected to the jet oil phase tank of the jet vibrator through a soft connection made of soft steel, while the other end thereof is connected to the reactor though a pipe. The junctions are located on the bottom of the reactor. The filter head in the water phase circulating system is a filter with an aperture of 200 μm, the constant-temperature condenser cooling water is used, and the circulating pump has a maximum flow rate of 2000 mL/min.

The specific steps will be given below.
(1) An oil phase containing the monomer styrene, the crosslinking agent divinylbenzene and the initiator azodiisobutyronitrile at a ratio of 93:7:1 was prepared, and a water phase mixed solution containing polyvinyl alcohol with a concentration of 1%, sodium dodecyl benzene sulfonate with a concentration of 0.01% and calcium carbonate with a concentration of 0.02% was prepared. The vibration vibrator was activated, the vibration frequency was adjusted as 180 Hz, and the vibration amplitude was adjusted as 0.02 mm. The oil phase was filled in the jet oil phase tank until the liquid level reached the jet micropore plate. The water phase was added to the spiral prepolymerization channel and the reactor.
(2) The temperature of the water phase in the spiral prepolymerization channel was kept at 80° C., and the temperature of the water phase in the reactor was kept at 90° C. The jet pump was activated, the flow rate was adjusted as 20 mL/min, and the temperature of the condenser was adjusted as 0° C. The circulating pump was activated, and the flow rate was adjusted as 2000 mL/min. The stirring speed in the reactor was set as 150 r/min.
(3) The oil phase was continuously pumped into the jet oil phase tank. The oil phase passed through the jet micropore plate to produce oil droplets under the action of vibration, and then entered the reactor through the spiral prepolymerization pipe. The temperature was kept for 10 h at 90° C.

The polymer white spheres synthesized after the steps (1) to (3) had a particle size of 550±30 μm, where D₅₀ was 561 Ilm, and the coefficient of uniformity was 1.17.

Other processes of the present invention can refer to the prior art.

Although the preferred embodiments of the present invention have been explained, further extensions made to the present invention by one person of ordinary skill in the art shall fall into the protection scope of the present invention.

What is claimed is:

1. A device for synthesizing homogeneous polymer spheres based on channel prepolymerization, wherein the device comprises a jet vibrator, a spiral prepolymerization channel (6), a reactor (12) and a water phase circulating system; two ends of the water phase circulating system are connected to the reactor (12) and the spiral prepolymerization channel (6) through pipes, respectively; the jet vibrator comprises a jet oil phase tank (3), a jet micropore plate (4) and a vibration exciter (1) for outputting vibration; the jet micropore plate (4) is arranged in the jet oil phase tank (3); and, an outlet end of the spiral prepolymerization channel (6) is connected to the reactor (12), while an inlet end thereof is connected to the jet oil phase tank (3).

2. The device for synthesizing homogeneous polymer spheres based on channel prepolymerization according to claim 1, wherein the jet vibrator further comprises a vibration platform (2), a vibration controller (7) and a jet pump (8); the vibration exciter (1) cooperates with the vibration controller (7) and the vibration platform (2) and is arranged in the vibration platform (2); the jet pump (8) is used in combination with the jet oil phase tank (3) and the jet micropore plate (4); and, the controllable flow range of the jet pump (8) is 0.5 mL/min to 200 mL/min.

3. The device for synthesizing homogeneous polymer spheres based on channel prepolymerization according to claim 1, wherein the water phase circulating system comprises a calculating pump (10) and a condenser (9); a junction of the water phase circulating system with the reactor (12) is located below an operating liquid level of the reactor (12); and, a filter head (11) is provided at the end of the water phase circulating system connected to the reactor (12).

4. The device for synthesizing homogeneous polymer spheres based on channel prepolymerization according to claim 1, wherein the circulating pump (10) has a flow rate of 0 mL/min to 2000 mL/min, and the filter head (11) has an aperture of 5 μm to 1000 μm.

5. The device for synthesizing homogeneous polymer spheres based on channel prepolymerization according to claim 1, wherein the spiral prepolymerization channel (6) comprises a heating interlayer, and the heating interlayer keeps the temperature of a water phase in the spiral prepolymerization channel (6) at 50° C. to 98° C.

6. The device for synthesizing homogeneous polymer spheres based on channel prepolymerization according to claim 1, wherein the spiral prepolymerization channel (6) is connected to the jet oil phase tank (3) through a soft connection (5); and, a spiral pipe in the spiral prepolymerization channel (6) has a diameter of 2 mm to 100 mm and a total length of 0.2 m to 50 m, and the spiral prepolymerization channel (6) has a spiral diameter of 1 cm to 200 cm and a pitch o 0.5 cm to 50 cm.

7. The device for synthesizing homogeneous polymer spheres based on channel prepolymerization according to claim 1, wherein the jet micropore plate (4) has a thickness of 0.5 mm to 5 mm, an aperture of 10 μm to 500 μm and a perforation rate of 0.0001% to 0.1%.

8. A method of using a device for synthesizing homogeneous polymer spheres based on channel prepolymerization according to claim 1, comprising the following steps of:
(1) adding an oil phase to the jet oil phase tank (3), and adding a water phase to the spiral prepolymerization channel (6) and the reactor (12);
(2) keeping the temperature of the water phase in the spiral prepolymerization channel (6) at 50° C. to 98° C. and the temperature of the water phase in the reactor (12) at 70° C. to 100° C., activating the vibration exciter (1), and activating the circulating pump (10) and the condenser (9); and
(3) continuously pumping the oil phase into the jet oil phase tank (3), and making oil droplets, which are generated by the oil phase through the jet micropore plate (4), pass through the spiral prepolymerization channel (6) under the action of excited vibration so as to enter the reactor (12), and keeping the temperature for 1 h to 10 h, preferably 4 h to 10 h.

9. The method of using a device for synthesizing homogeneous polymer spheres based on channel prepolymerization according to claim 8, wherein the oil droplets reside in the spiral prepolymerization channel (6) for 1 min to 200 min.

10. The method of using a device for synthesizing homogeneous polymer spheres based on channel prepolymerization according to claim 8, wherein the vibration exciter (1) has a vibration frequency of 1 Hz to 1000 Hz, preferably 10 Hz to 100 Hz, and has a vibration amplitude of 0.1 μm to 10 mm, preferably 0.1 μm to 8 mm.
